(19) United States
(12) Patent Application Publication
(10) Pub. No.: US 2011/0087342 A1
(43) Pub. Date: Apr. 14, 2011

(54) ULTRASONIC SENSOR AND CONTROLLING METHOD USING THE SAME

(75) Inventors: Sian-Cing Liao, Hsinchu (TW); Yuan-Hung Liao, Hsinchu (TW)

(73) Assignee: LITE-ON IT CORP., Taipei City (TW)

(21) Appl. No.: 12/901,269

(22) Filed: Oct. 8, 2010

(30) Foreign Application Priority Data
Oct. 10, 2009 (CN) 200910204699.2

(51) Int. Cl. G01N 29/00; G05B 13/02

(52) U.S. Cl. 700/32; 702/56

(57) ABSTRACT

A controlling method using an ultrasonic sensor is provided. Firstly, a first ringing time of the ultrasonic sensor is set when the ultrasonic sensor is in a standby status. Then, a sensing wave is transmitted, and a second ringing time is detected. Then, the second ringing time is compared with the first ringing time. If the second ringing time is not equal to the first ringing time, a function control signal is generated.

This application claims the benefit of People's Republic of China application Serial No. 200910204699.2, filed Oct. 10, 2009, the subject matter of which is incorporated herein by reference.

### FIELD OF THE INVENTION

The present invention relates to an ultrasonic sensor, and more particularly to an ultrasonic sensor for controlling an operating status or a specified function of an electronic device according to the ringing time. The present invention also relates to a controlling method using the ultrasonic sensor.

### BACKGROUND OF THE INVENTION

An ultrasonic sensor is a device that uses the sensing technology of ultrasonic waves. In the present implements, the ultrasonic sensor can be a single-transmitting type, which only have the function of transmitting designated-frequency ultrasonic waves but not have the function of receiving the ultrasonic waves. Another type of ultrasonic sensor contains both functions of transmitting and receiving the ultrasonic waves, which is achieved by include two operated elements in a single housing, wherein one of the elements is a transmitter, and the other is a receiver. That is, a transmitter and a receiver are included in the ultrasonic sensor. The transmitter and the receiver face the same side to transmit an ultrasonic wave and receive the reflected ultrasonic wave, respectively. For determining the distance from an object to the ultrasonic sensor, the ultrasonic sensor generates a high frequency ultrasonic wave and evaluates the reflective wave which is returned back to the ultrasonic sensor. When the reflective wave is received, the ultrasonic sensor will calculate the time interval between generation of the ultrasonic wave and receipt of the reflective wave, thereby acquiring a time of flight (TOF).

Conventionally, the transmitter of the ultrasonic sensor is formed of a piezoelectric film. The piezoelectric film is driven to generate vibration in response to a driving signal having constant amplitude and about 40 KHz frequency. Due to the mechanic property of vibration, the piezoelectric film does not stop vibrating in a short time period after the driving signal is stopped. As such, a ringing phenomenon occurs. Although the vibration of the piezoelectric film is gradually decayed during this time period, a decay signal with a corresponding waveform is generated. Since the transmitter and the receiver of the ultrasonic sensor are included in the same module, after the reflective wave is received by the receiver, the reflective wave may vibrate the piezoelectric film to generate an echo signal with a corresponding waveform. If the distance between the ultrasonic sensor and the object is too short, the waveform or decay signal resulted from the ringing phenomenon has adverse influences on the performance of receiving the reflective wave.

FIG. 1A is a schematic timing waveform diagram illustrating associated signals of an ultrasonic sensor for distance determination according to the prior art. In response to a driving signal DS (in the lower-left part of the drawing), the piezoelectric film within the ultrasonic sensor generates corresponding vibration. The vibration of the piezoelectric film has a waveform of an oscillation signal OS (in the upper-left part of the drawing). In response to the oscillation signal OS, the ultrasonic sensor generates and transmits an ultrasonic wave. At the time spot to, the driving signal DS is stopped and a ringing phenomenon occurs. Due to the ringing phenomenon, the oscillation signal OS is not immediately stopped but the amplitude thereof is gradually decreased as a decay signal RS. When the oscillation signal OS is reflected by an object, an echo signal ES (in the upper-right part of the drawing) is returned back to the ultrasonic sensor.

For avoiding erroneous judgment resulted from noise, a threshold level L is employed as a criterion for judging whether the object is actually detected. For example, the threshold level L is 1V or any other value. In a case that the amplitude of the echo signal ES is greater than the threshold level L, the ultrasonic sensor may judge that the object is within the sensing range. At the time spot t2 when the amplitude of the echo signal ES is just greater than the threshold level L, the object is detected. According to the time spot t2, the distance between the ultrasonic sensor and the object is calculated.

The time interval from termination of the driving signal DS to the time spot when the oscillation signal OS is reduced to the threshold level L is called as a dead zone Zd. In other words, after the amplitude of the decay signal RS is smaller than the threshold level L (the time spot t1), the influence of the decay signal RS on receiving the echo signal ES is considered to be negligible.

On the other hand, if the distance of the object from the ultrasonic sensor is too short, the time interval between generation of the ultrasonic sound wave and receipt of the reflective wave is very small. As such, the echo signal ES is very close to the decay signal RS, or the time spot of receiving the echo signal ES is earlier than the time spot when the oscillation signal OS is reduced to the threshold level L (i.e. decaying completion of the decay signal RS). Since the transmitter and the receiver are included in a same ultrasonic sensor or transmitting/receiving module, it is impossible to differentiate the echo signal ES and the decay signal RS if the echo signal ES and the decay signal RS are mixed.

FIG. 1B is a schematic timing waveform diagram illustrating associated signals of an ultrasonic sensor for distance determination according to the prior art, in which the echo signal and the decay signal are mixed. As shown in FIG. 1B, the amplitude of the decay signal RS is smaller than the threshold level L at the time spot t1′. The decay time is so long that the range of the dead zone Zd is very wide. In addition, since the distance of the object from the ultrasonic sensor is too short, the time spot of receiving the echo signal ES (at the time spot t2′) is earlier than the time spot when the decay signal RS is reduced to the threshold level L (at the time spot t1′). In other words, the echo signal ES and the decay signal RS are mixed. Under this circumstance, the processor fails to clearly judge the time spot of receiving the reflective wave and the corresponding waveform. Due to the limitation of the dead zone Zd, the ultrasonic sensor is not effective for determining the distance of a nearby object.

In order to determine the distance of a nearby object, the literatures disclosed some methods of narrowing the dead zone or shortening the ringing time. Since these conventional methods need to change or add the circuitry layout of the ultrasonic sensor or write a complicated program or firmware, the fabricating cost of the ultrasonic sensor is increased. Therefore, there is a need of providing a controlling method by utilizing the ringing phenomenon and the ringing time.

### SUMMARY OF THE INVENTION

The present invention provides an ultrasonic sensor for controlling an operating status or a specified function of an electronic device according to the ringing time. The present invention also relates to a controlling method using the ultrasonic sensor.

In accordance with an aspect of the present invention, there is provided a controlling method by using an ultrasonic sensor. Firstly, a first ringing time of the ultrasonic sensor is set when the ultrasonic sensor is in a standby status. Then, a sensing wave is transmitted, and a second ringing time is detected. Then, the second ringing time is compared with the first ringing time. If the second ringing time is not equal to the first ringing time, a function control signal is generated.

In accordance with another aspect of the present invention, there is provided an ultrasonic sensor. The ultrasonic sensor includes a pre-processing module, an ultrasonic transmitting/receiving module and a microprocessor. The pre-processing module is used for generating a driving signal. The ultrasonic transmitting/receiving module is in communication with the pre-processing module for receiving the driving signal, and generating vibration and transmitting a sensing wave according to the driving signal. The ultrasonic transmitting/receiving module has a first ringing time in a standby status. When the sensing wave is reflected by an object to generate a reflective wave, a second ringing time required for completing a decaying course is obtained. The microprocessor is in communication with the pre-processing module for controlling the pre-processing module to generate the driving signal, and comparing the second ringing time with the first ringing time. If the second ringing time is not equal to the first ringing time, the microprocessor generates a function control signal.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic timing waveform diagram illustrating associated signals of an ultrasonic sensor for distance determination according to the prior art;

FIG. 1B is a schematic timing waveform diagram illustrating associated signals of an ultrasonic sensor for distance determination according to the prior art, in which the echo signal and the decay signal are mixed;

FIG. 2 is a schematic functional block diagram illustrating an ultrasonic sensor according to an embodiment of the present invention;

FIG. 3 is a schematic diagram illustrating a light output control method of a lighting device by using the ultrasonic sensor of the present invention;

FIG. 4A is a schematic timing waveform diagram illustrating associated signals of an ultrasonic sensor according to a first embodiment of the present invention, in which an open-type ultrasonic transmitting/receiving module of the ultrasonic sensor is in a standby status;

FIG. 4B is a schematic timing waveform diagram illustrating associated signals of an ultrasonic sensor according to the first embodiment of the present invention, in which an object enters the first controlling area of the open-type ultrasonic transmitting/receiving module;

FIG. 5A is a schematic timing waveform diagram illustrating associated signals of an ultrasonic sensor according to a second embodiment of the present invention, in which a close-type ultrasonic transmitting/receiving module of the ultrasonic sensor is in a standby status;

FIG. 5B is a schematic timing waveform diagram illustrating associated signals of an ultrasonic sensor according to the second embodiment of the present invention, in which an object enters the first controlling area of the close-type ultrasonic transmitting/receiving module;

FIG. 6 is a schematic view illustrating that the surface of the ultrasonic transmitting/receiving module is touched by an object;

FIG. 7 is a flowchart illustrating a first exemplary controlling method according to the present invention; and

FIG. 8 is a flowchart illustrating a second exemplary controlling method according to the present invention.

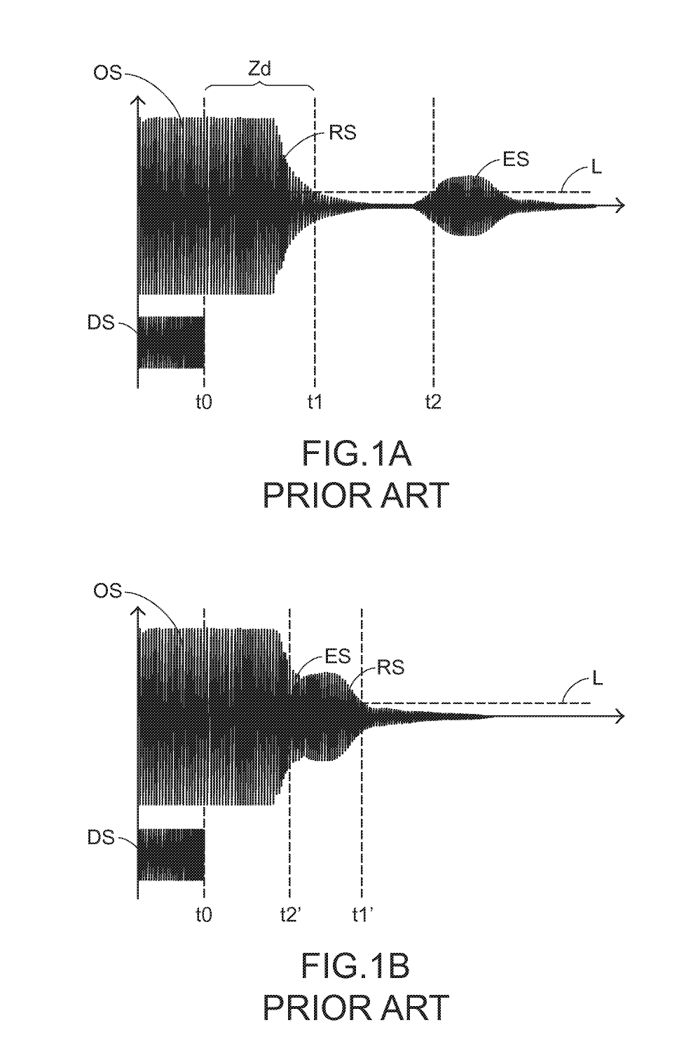

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As previously described, if the distance between the ultrasonic sensor and the object is too short, the performance of receiving the reflective wave is adversely affected by the ringing phenomenon or the ringing time. In other words, since the time spot of receiving the reflective wave fails to be clearly realized, the ultrasonic sensor is not effective for determining the distance of a nearby object. Since ultrasonic wave generated from the vibration of the piezoelectric film of the ultrasonic sensor results in a decay signal with a decay time, the ringing time could be considered as a constant value. If the distance between a nearby object and the ultrasonic sensor is too short, the decay time or the ringing time will be changed. According to a change of the decay time or a change of the ringing time, the controlling method of the present invention can control the operating status of an electronic device (e.g. a lighting device) or enable/disable a specified function.

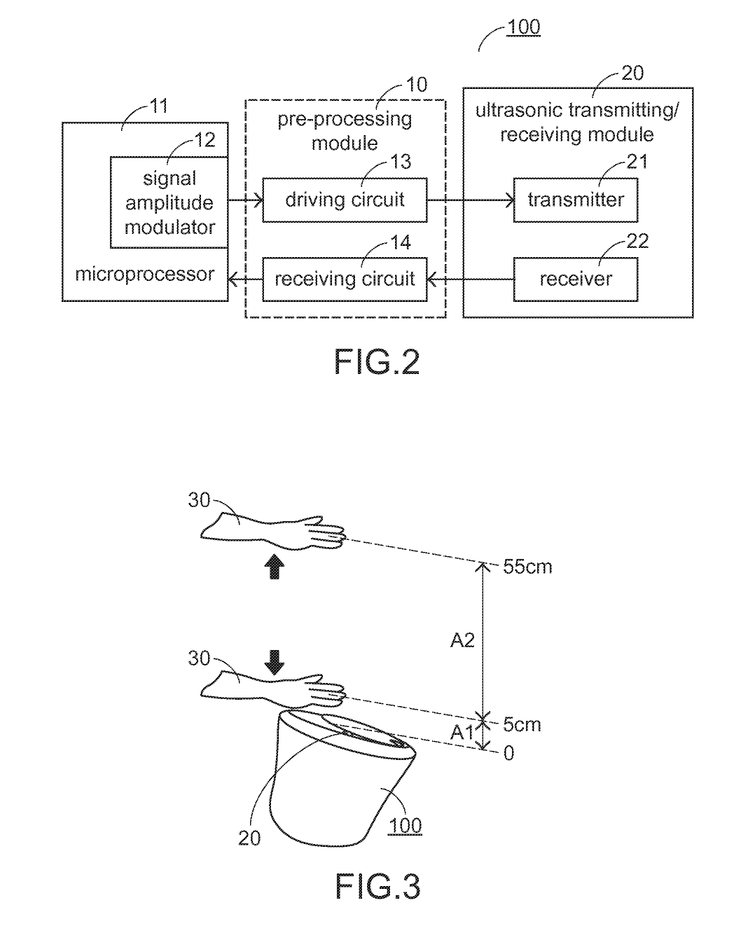

FIG. 2 is a schematic functional block diagram illustrating an ultrasonic sensor according to an embodiment of the present invention. As shown in FIG. 2, the ultrasonic sensor 100 comprises a microprocessor 11, a pre-processing module 10 and an ultrasonic transmitting/receiving module 20. The microprocessor 11 comprises a signal amplitude modulator 12. The pre-processing module 10 comprises a driving circuit 13 and a receiving circuit 14. The ultrasonic transmitting/receiving module 20 comprises a transmitter 21 for transmitting an ultrasonic wave and a receiver 22 for receiving a reflective wave. This drawing also indicates the relationship between these components. The ultrasonic sensor 100 can determine the distance between an object (not shown) and the ultrasonic sensor 100. Without any additional component, the controlling method of the present invention is employed to control corresponding functions according to a change of the ringing time of the ultrasonic sensor 100.

In this embodiment, the ultrasonic sensor 100 is applied to a lighting device. FIG. 3 is a schematic diagram illustrating a light output control method of a lighting device by using the ultrasonic sensor of the present invention. The ultrasonic sensor 100 may sense a motion of an object 30 (e.g. a user's hand) to determine the distance of the object 30 from the ultrasonic sensor 100 according to the time of flight (TOF). According to the distance change, the operating status of the lighting device is adjusted or changed.

The lighting device includes plural light-emitting elements such as LEDs (not shown). By a proper controlling method, these light-emitting elements cooperate with each other to produce resulting light with multi-stage combination of color and brightness. For example, according to the motion of the user's hand 30 that is sensed by the ultrasonic sensor 100, the color and brightness of the light produced by the lighting device will be adaptively adjusted, selected or changed. For example, according to a specified controlling strategy, the light produced by the lighting device has darker brightness or colder color as the user's hand 30 is closer to the ultrasonic sensor 100; otherwise, the light produced by the lighting device has brighter brightness or warmer color as the user's hand 30 is farther from the ultrasonic sensor 100.

As shown in FIG. 3, the ultrasonic transmitting/receiving module 20 is disposed on the outer surface of the ultrasonic sensor 100 for transmitting a sensing wave and receiving a reflective wave. In practice, the ultrasonic transmitting/receiving module 20 has an effective sensing range and a dead zone that is ineffective to determine the distance of a nearby object. For example, in a case that the object 30 is within a first controlling area A1, the ultrasonic transmitting/receiving module 20 fails to effectively determine the distance of the object 30 because the distance is too short. Whereas, in a case that the object 30 is within a second controlling area A2, the motion of the object could be effectively sensed by the ultrasonic transmitting/receiving module 20 in order to implement associated controlling strategy. Generally, the first controlling area A1 is ranged between the surface of the ultrasonic transmitting/receiving module 20 (distance=0) and a first distance over the surface of the ultrasonic transmitting/receiving module 20 (e.g. 5 cm). The second controlling area A2 is ranged between the first controlling area A1 and a second distance over the surface of the ultrasonic transmitting/receiving module 20 (e.g. 55 cm).

That is, even if the second controlling area A2 provides a relatively broader space for permitting the motion of the user's hand, the ultrasonic sensor 100 fails to normally function when the user's hand enters the first controlling area A1. In addition, since the distance of the object 30 fails to be effectively determined, the ultrasonic sensor 100 makes no response. In a case that the ultrasonic transmitting/receiving module 20 of the ultrasonic sensor 100 is operated in a standby status, the ultrasonic transmitting/receiving module 20 has a first ringing time according to the inherent property or the original design. When an object enters the first controlling area A1, the reflective wave and the decay signal resulted from vibration of the ultrasonic transmitting/receiving module are mixed and thus the distance fails to be effectively determined. From the above discussion, the ultrasonic sensor 100 could normally function when the object enters the second controlling area A2, but the ultrasonic sensor 100 fails to normally function when the object enters the first controlling area A1.

In accordance with a key feature of the present invention, the operating status of an electronic device to be controlled is switched between an ON status and an OFF status when an object is within the first controlling area A1. In other words, only a controlling mechanism corresponding to the first controlling area A1 is added, but the hardware or software associated with the controlling mechanism of the second controlling area A2 is kept unchanged. By judging whether the ringing time is changed, the microprocessor 11 will control a corresponding operation. Without any additional hardware component (e.g. a circuitry) or complicate process of rewriting the program, the controlling method of the present invention only needs a simple control program. The control program is executed in the microprocessor 11 to judge whether the ringing time is changed and perform a corresponding controlling operation.

Generally, the current ultrasonic transmitting/receiving modules are classified into two types, i.e. an open type and a close type. The two types of ultrasonic transmitting/receiving modules have different responses to the ringing time when a nearby object is sensed. Hereinafter, an open-type ultrasonic transmitting/receiving module and a close-type ultrasonic transmitting/receiving module will be illustrated with reference to the first and second embodiments.

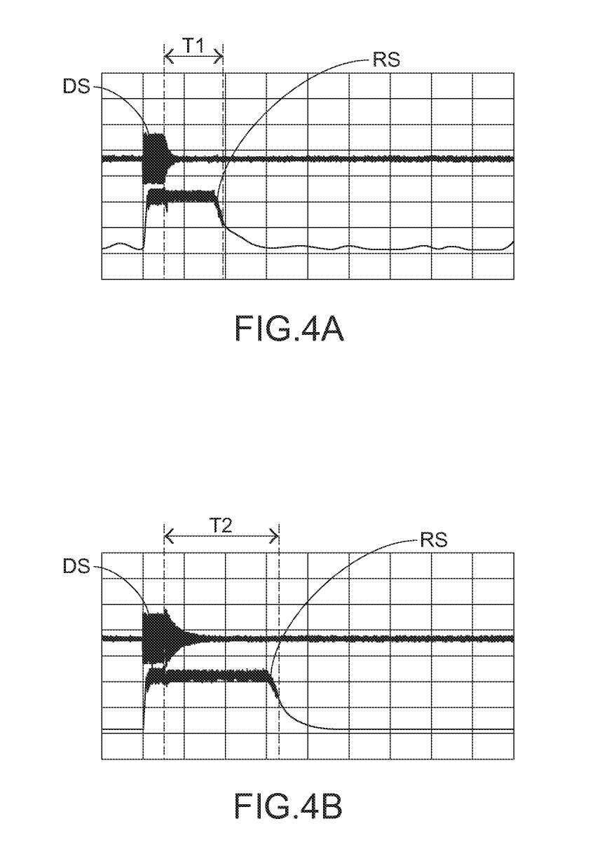

FIG. 4A is a schematic timing waveform diagram illustrating associated signals of an ultrasonic sensor according to a first embodiment of the present invention, in which an open-type ultrasonic transmitting/receiving module of the ultrasonic sensor is in a standby status. Firstly, a driving signal DS is generated by the pre-processing module 10. Especially, the signal amplitude modulator 12 of the microprocessor 11 may control the driving circuit 13 of the pre-processing module 10 to generate the driving signal DS. When the driving signal DS is received by the transmitter 21 of the ultrasonic transmitting/receiving module 20, the transmitter 21 generates corresponding vibration and transmits a sensing wave. Once the sensing wave is reflected by the object 30, the reflective wave is returned back to the ultrasonic sensor 100 and received by the receiver 22 of the ultrasonic transmitting/receiving module 20.

As shown in FIG. 4A, when the ultrasonic transmitting/receiving module 20 is in the standby status, it takes a first ringing time T1 for completing the decaying course. In other words, if no object is detected, after the driving signal DS is stopped, the first ringing time T1 is required for the decaying completion of the decay signal RS. On the other hand, if the object 30 enters the first controlling area A1 (see FIG. 3) by moving the object 30 within the range from the surface to 5 cm above the ultrasonic transmitting/receiving module 20 or touching the surface of the ultrasonic transmitting/receiving module 20 (see FIG. 6), the ultrasonic transmitting/receiving module 20 may be interfered by the reflective wave.

For an open-type ultrasonic transmitting/receiving module 20, since the reflective wave causes vibration within the ultrasonic transmitting/receiving module 20 and the reflective wave is mixed with the decay signal RS, the ringing time is prolonged. The reflective wave is received by the receiving circuit 14 of the pre-processing module 10. Via the receiving circuit 14, the microprocessor 11 may realize the decaying completion of the ultrasonic transmitting/receiving module 20. That is, a second ringing time T2 is required for the decaying completion of the decay signal RS. FIG. 4B is a schematic timing waveform diagram illustrating associated signals of an ultrasonic sensor according to the first embodiment of the present invention, in which an object enters the first controlling area of the open-type ultrasonic transmitting/receiving module. Since the object 30 enters the first controlling area A1, the second ringing time T2 is longer than the first ringing time T1.

On the other hand, if the object 30 is not within the range from the surface to 5 cm above the ultrasonic transmitting/receiving module 20 or the surface of the ultrasonic transmitting/receiving module 20 is not touched by the object 30, the second ringing time T2 is substantially equal to the first ringing time T1.

According to the settings of the microprocessor 11, the ultrasonic sensor has a first ringing time T1 in the standby status. After the second ringing time T2 is acquired, the microprocessor 11 may compare the second ringing time T2 with the first ringing time T1. In this embodiment, if the comparing result indicates that the second ringing time T2 is greater than the first ringing time T1, the microprocessor 11 issues a function control signal (not shown). That is, the motion of the object 30 within the first controlling area Al causes a change of the ringing time. According to the comparing result obtained by the microprocessor 11, the controlling method of the present invention may be designed to have a two-stage switching mechanism.

For example, in response to the function control signal, the operating status of an electronic device to be controlled is switched between an ON status and an OFF status. That is, when the user's hand is near the ultrasonic sensor and the first ringing time T1 and the second ringing time T2 are different, the operating status of the electronic device is switched to the ON status or the OFF status.

Especially, in response to the function control signal, the operating status of the electronic device is switched from the ON status to the OFF status, or from the OFF status to the ON status. In a case that the ultrasonic sensor is applied to a lighting device, the lighting device is turned on in the ON status, but the lighting device is turned off in the OFF status. Alternatively, a specified function of the lighting device is enabled in the ON status, but the specified function of the lighting device is disabled in the OFF status. Although the ultrasonic sensor fails to effectively determine the distance of a nearby object, the feature of the ringing time change of the ultrasonic sensor can be utilized to trigger or control a specified function without the need of adding any other hardware component (e.g. a physical switch or key).

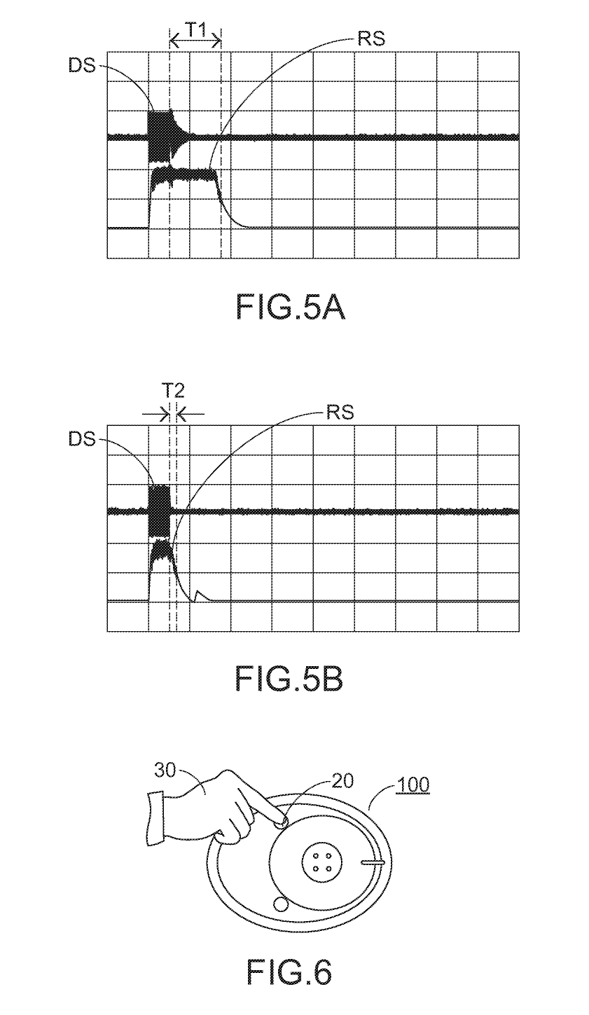

FIG. 5A is a schematic timing waveform diagram illustrating associated signals of an ultrasonic sensor according to a second embodiment of the present invention, in which a close-type ultrasonic transmitting/receiving module of the ultrasonic sensor is in a standby status. The process of generating associated signal in this embodiment are similar to those illustrated in the first embodiment, and are not redundantly described herein. As shown in FIG. 5A, when the ultrasonic transmitting/receiving module 20 is in the standby status, it takes a first ringing time T1 for completing the decaying course. FIG. 6 is a schematic view illustrating that the surface of the ultrasonic transmitting/receiving module is touched by an object. If the surface of the close-type ultrasonic transmitting/receiving module 20 is touched by the object 30, the ringing time of the ultrasonic transmitting/receiving module 20 is changed.

FIG. 5B is a schematic timing waveform diagram illustrating associated signals of an ultrasonic sensor according to the second embodiment of the present invention, in which an object enters the first controlling area of the close-type ultrasonic transmitting/receiving module. Since the close-type ultrasonic transmitting/receiving module 20 is an integral component, if the surface is pressed, sheltered or touched by an object, the mechanical oscillation after the driving signal is stopped will be alleviated. In other words, the ringing time is shortened. That is, if the ultrasonic transmitting/receiving module 20 is touched by the object 30, the second ringing time T2 is shorter than the first ringing time T1.

On the other hand, if the surface of the ultrasonic transmitting/receiving module 20 is not touched by the object 30, the second ringing time T2 is substantially equal to the first ringing time T1.

According to the settings of the microprocessor 11, the ultrasonic sensor has a first ringing time T1 in the standby status. After the second ringing time T2 is acquired, the microprocessor 11 may compare the second ringing time T2 with the first ringing time T1. In this embodiment, if the comparing result indicates that the second ringing time T2 is smaller than the first ringing time T1, the microprocessor 11 issues a function control signal. Similarly, in response to the function control signal, the operating status of an electronic device to be controlled is switched between an ON status and an OFF status. Especially, in response to the function control signal, the operating status of the electronic device is switched from the ON status to the OFF status, or from the OFF status to the ON status. In a case that the ultrasonic sensor is applied to a lighting device, the lighting device is turned on in the ON status, but the lighting device is turned off in the OFF status. Alternatively, a specified function of the lighting device is enabled in the ON status, but the specified function of the lighting device is disabled in the OFF status.

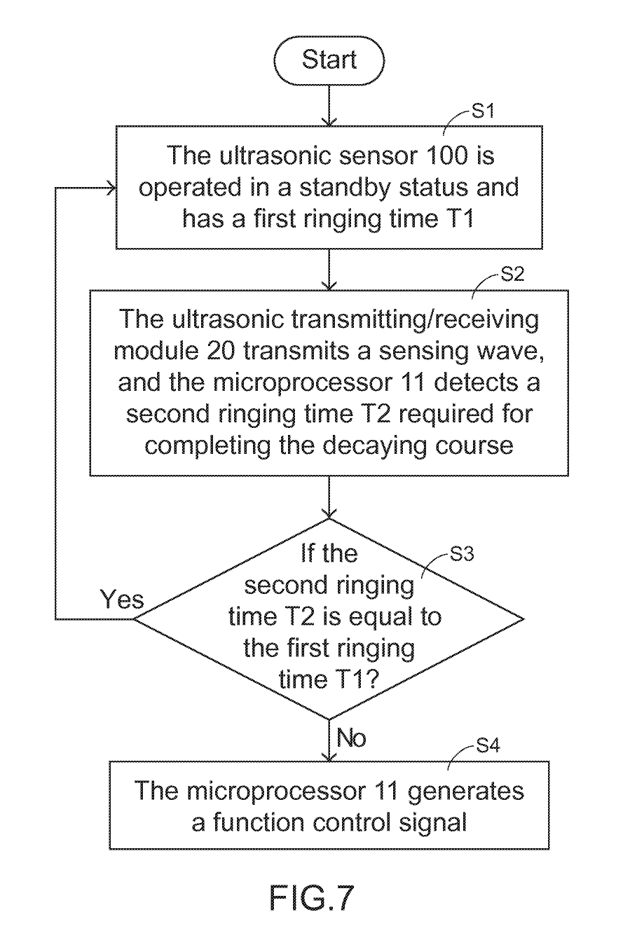

FIG. 7 is a flowchart illustrating a first exemplary controlling method according to the present invention. Firstly, the ultrasonic sensor 100 is operated in a standby status and has a first ringing time T1 (Step S1). In Step S1, the microprocessor 11 can calculate a time interval required for completing a decaying course when the ultrasonic sensor 100 is in a standby status, and defining this time interval as the first ringing time T1. Then, the ultrasonic transmitting/receiving module 20 transmits a sensing wave, and the microprocessor 11 detects a second ringing time T2 required for completing the decaying course (Step S2). If the second ringing time T2 is not equal to the first ringing time T1 (for example, T2 is greater than T1 for the open-type ultrasonic transmitting/receiving module, or T2 is smaller than T1 for the close-type ultrasonic transmitting/receiving module) (Step S3), the microprocessor 11 issues a function control signal (Step S4). In response to the function control signal, the operating status is switched between an ON status and an OFF status.

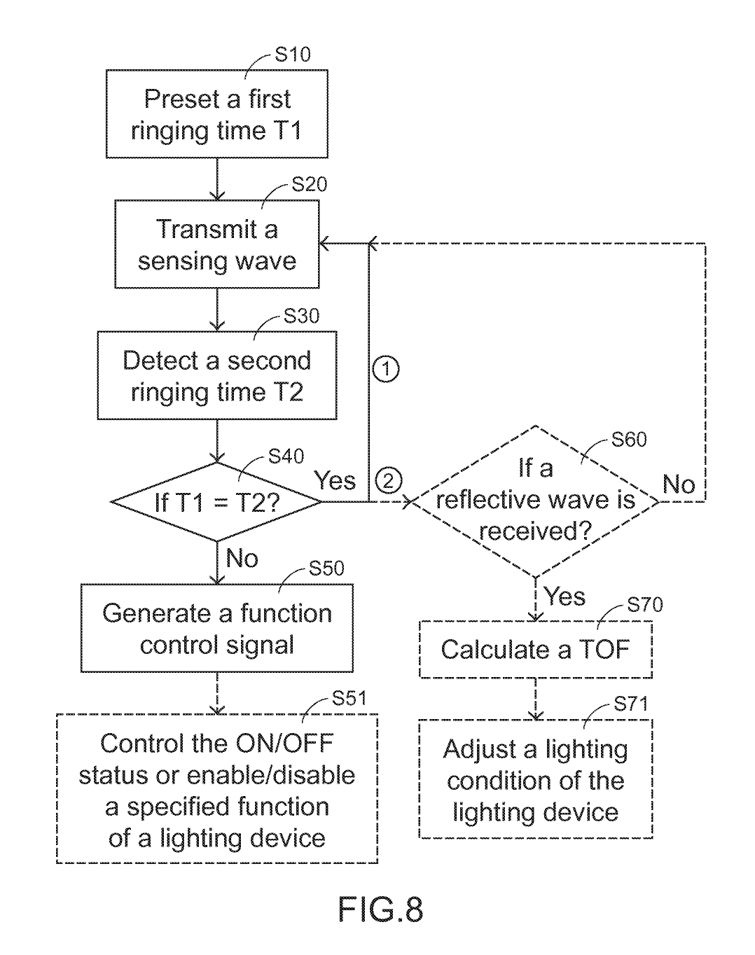

FIG. 8 is a flowchart illustrating a second exemplary controlling method according to the present invention. Firstly, the microprocessor 11 calculates a time interval required for completing a decaying course when the ultrasonic sensor 100 is in a standby status, and defining this time interval as the first ringing time T1 (Step S10). Then, the ultrasonic transmitting/receiving module 20 transmits a sensing wave (Step S20), and the microprocessor 11 detects a second ringing time T2 corresponding to the sensing wave (Step S30). Then, the microprocessor 11 judges whether the second ringing time T2 is equal to the first ringing time T1 (Step S40). Once the second ringing time T2 is not equal to the first ringing time T1, the microprocessor 11 generates a function control signal (Step S50). In response to the function control signal, the operating status is switched between an ON status and an OFF status.

In a case that the ultrasonic sensor is applied to a lighting device, the lighting device is turned on in the ON status, but the lighting device is turned off in the OFF status. Alternatively, a specified function of the lighting device is enabled in the ON status, but the specified function of the lighting device is disabled in the OFF status (Step S51).

Once the second ringing time T2 is equal to the first ringing time T1 (Step S40), the controlling method returns to Step S20.

In another embodiment, once the second ringing time T2 is equal to the first ringing time T1 (Step S40), the microprocessor 11 further detects whether a reflective wave is received (Step S60). Once a reflective wave is received, the microprocessor 11 calculates a time of flight (TOF) according to generation of the sensing wave and receipt of the reflective wave (Step S70). Whereas, once no reflective wave is received, the controlling method returns to Step S20.

In a case that the ultrasonic sensor is applied to a lighting device, the lighting condition of the lighting device is adjusted by the microprocessor 11 according to the time of flight (TOF) (Step S71). For example, the lighting condition comprises brightness or color of the light produced by the lighting device.

In the above embodiments, the present invention is illustrated by referring to an ultrasonic sensor used in a lighting device. Nevertheless, the ultrasonic sensor and the controlling method of the present invention may be applied to any other electronic device. In the above embodiments, the controlling method of the present invention is designed to have a two-stage switching mechanism such that the electronic device is operated in an ON status or an OFF status. In a case that an object 30 enters the first controlling area A1 of the ultrasonic transmitting/receiving module 20 or the surface of the ultrasonic transmitting/receiving module 20 is touched by the object 30, the two-stage switching mechanism is rendered because the ringing time is changed. Moreover, any other operating condition with a two-stage switching feature could be adjusted or controlled by using the controlling method of the present invention. In other words, the controlling method of the present invention is not restricted to the switching function.

Even if the distance between an object (or a user's hand) and the ultrasonic sensor is very small and fails to effectively determine the distance, the controlling method of the present invention is capable of controlling the ON/OFF status or enabling/disabling a specified function of an electronic device according to a change of the ringing time. Since the unfavorable factor (i.e. ringing time) of the conventional ultrasonic sensor could be employed to implement the controlling method of the present invention, no additional hardware component is required and the fabricating cost of the ultrasonic sensor is reduced.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A controlling method by using an ultrasonic sensor, the controlling method comprising steps of:
(a) setting a first ringing time of the ultrasonic sensor when the ultrasonic sensor is in a standby status;
(b) transmitting a sensing wave, and detecting a second ringing time; and
(c) comparing the second ringing time with the first ringing time, wherein if the second ringing time is not equal to the first ringing time, a function control signal is generated.

2. The controlling method according to claim 1 wherein in response to the function control signal, a two-stage switching mechanism is rendered.

3. The controlling method according to claim 1 wherein when the ultrasonic sensor is used in an electronic device, in response to the function control signal, the operating status of the electronic device is switched between an ON status and an OFF status.

4. The controlling method according to claim 1 wherein when the ultrasonic sensor is used in a lighting device, in response to the function control signal, the lighting device is turned on or turned off.

5. The controlling method according to claim 1 wherein when the ultrasonic sensor is used in a lighting device, in response to the function control signal, a specified function is enabled or disabled.

6. The controlling method according to claim 1 wherein if the second ringing time is equal to the first ringing time, the controlling method further comprises steps of:
judging whether a reflective wave is received; and
calculating a time of flight according to generation of the sensing wave and receipt of the reflective wave once the reflective wave is received, wherein once the reflective wave is not received, the steps (b) and (c) are repeatedly done.

7. The controlling method according to claim 6 wherein when the ultrasonic sensor is used in a lighting device, the controlling method further comprises a step of controlling a lighting condition of the lighting device according to the time of flight.

8. The controlling method according to claim 7 wherein lighting condition comprises brightness or color of the light emitted by the lighting device.

9. An ultrasonic sensor comprising:
a pre-processing module for generating a driving signal;
an ultrasonic transmitting/receiving module in communication with the pre-processing module for receiving the driving signal, and generating vibration and transmitting a sensing wave according to the driving signal, wherein the ultrasonic transmitting/receiving module has a first ringing time in a standby status, wherein when the sensing wave is reflected by an object to generate a reflective wave, a second ringing time required for completing a decaying course is obtained; and
a microprocessor in communication with the pre-processing module for controlling the pre-processing module to generate the driving signal, and comparing the second ringing time with the first ringing time, wherein if the second ringing time is not equal to the first ringing time, the microprocessor generates a function control signal.

10. The ultrasonic sensor according to claim 9 wherein when the ultrasonic sensor is used in an electronic device, in response to the function control signal, the operating status of the electronic device is switched between an ON status and an OFF status.

11. The ultrasonic sensor according to claim 9 wherein when the object is within a first controlling area with respect to the ultrasonic transmitting/receiving module, the ultrasonic transmitting/receiving module is in an interference status.

12. The ultrasonic sensor according to claim 11 wherein if the ultrasonic transmitting/receiving module is an open-type ultrasonic transmitting/receiving module, the second ringing time is greater than the first ringing time when the ultrasonic transmitting/receiving module is in the interference status.

13. The ultrasonic sensor according to claim 11 wherein if the ultrasonic transmitting/receiving module is a close-type ultrasonic transmitting/receiving module, the second ringing time is smaller than the first ringing time when the ultrasonic transmitting/receiving module is in the interference status.

14. The ultrasonic sensor according to claim 11 wherein the first controlling area is ranged from a surface of the ultrasonic transmitting/receiving module to a first distance over the ultrasonic transmitting/receiving module.

15. The ultrasonic sensor according to claim 11 wherein when the ultrasonic sensor is used in an electronic device and the object is within a second controlling area with respect to the ultrasonic transmitting/receiving module, at least one operating condition of the electronic device is adjustable.

16. The ultrasonic sensor according to claim 15 wherein the second controlling area is ranged from the first controlling area to a second distance over the ultrasonic transmitting/receiving module.
